(19) United States
(12) Patent Application Publication
(10) Pub. No.: US 2013/0298420 A1
(43) Pub. Date: Nov. 14, 2013

(54) PAINT DRYING METHOD

(71) Applicants: Ruediger Detzer, Buseck (DE); Thomas Winkler, Grobensee (DE)

(72) Inventors: Ruediger Detzer, Buseck (DE); Thomas Winkler, Grobensee (DE)

(21) Appl. No.: 13/808,765

(22) PCT Filed: Feb. 1, 2012
(86) PCT No.: PCT/EP2012/051704

§ 371 Date: Jan. 7, 2013

(30) Foreign Application Priority Data
Feb. 1, 2011 (DE) 102011000440.8

(51) Int. Cl. F26B 21/00

(52) U.S. Cl. CPC F26B 21/004
USPC 34/443; 34/523

(57) ABSTRACT

A method for drying a component provided with a paint application via supplied warm air, including supplying the warm air at a predefined horizontal distance from the component in the base or fastening or standing region of the component. The warm air is supplied with a low momentum, and is guided via thermal flow effects substantially vertically along the component thereby achieving and sustaining a surface related homogenous surface temperature of the component, which in particular is higher than the ambient or room air temperature in the paint shop.

The invention relates to a method for drying a component provided with a paint application by means of supplied warm air and an arrangement for this purpose.

### PRIOR ART

In aircraft the fuselage is usually painted in one colour and the vertical stabilizer is usually painted multi-colour. Two-component paints are used here, which after application conventionally dry for 12 to 24 hours depending on the paint system, where the drying time also depends on the hardener used and on the ambient conditions.

The paint is applied in the paint shops, which for itself already takes several hours. The paint application is followed by a first ventilation of the painted component during a flash-off time of about one to two hours in order to ensure that the air-solvent mixture present in the paint shop is no longer explosive.

The drying then takes place. During the drying the paint dries on the component at room air temperatures in the range of, for example, 20° C. to 23° C. In the process prepared external air is supplied continuously to the paint shop. The supply of air usually takes place above the component. In principle, it is possible to shorten the drying time by increasing the heat output. However, care should be taken here to ensure that too-rapid drying of the surface and therefore a surface compaction with the result that out-diffusion of the solvent from the freshly applied paint would be rendered difficult does not take place.

### DESCRIPTION OF THE INVENTION

### Object, Solution, Advantages

It is therefore the object of the invention to provide a paint drying method that operates more energy-efficiently and rapidly than the known drying methods.

The method according to the invention according to claim 1 and an arrangement according to claim 8 is proposed to solve this object.

The method is characterized in that the warm air is supplied with a low momentum at a predefined horizontal distance from the component in the base or fastening or standing region of the component, and in order to achieve and sustain an, in particular surface-related homogenous surface temperature of the component, which in particular is higher than the ambient or room air temperature in the paint shop, is guided by means of thermal flow effects substantially vertically along the component and/or over and along the surface of the component.

The maximum value of the component surface temperature is limited by the paint system used.

A component to be painted on its surface, for example, an aircraft vertical stabilizer, an aircraft fuselage, an aircraft wing, or a vehicle component such as a motor vehicle component, is provided as component.

The special inventive idea consists in that after the painting, appropriate air flows are brought to the painted component to be dried and in particular are released with a low momentum in the direct surroundings of the component at a predefined distance, where the airflows consists of air, heated compared with the ambient or room temperature air in the paint shop, so that a flow over the paint surface of the component results by means of the thermals.

According to one embodiment of the method, it is provided that appropriate air flows are brought to the painted component to be dried and are released with a low momentum in the direct surroundings of the component at a predefined distance, where the air flow consists of air heated, compared with the ambient or room temperature air in the paint shop, so that a flow over the surface of the component results by means of the thermals. The air supply advantageously happens here such that heated air sweeps over the component in appropriate quantity and the moisture diffusing out from the paint and/or the solvent is removed. The drying takes place here in a controlled manner so that the component surface or the paint surface are optimally temperature-controlled so that a rapid release of moisture and/or solvent can take place without any closure of the paint surface.

This is achieved in particular as a result of the advantageous arrangement of the air outflow source. For this purpose, it is provided that at least one air source arranged at a horizontal and/or vertical distance from the component, running approximately parallel to the ground and/or running approximately horizontally is used as air outflow source. Preferably a pipe section and/or a hose section, which is arranged at a distance, measured between the central longitudinal axis of the pipe or hose section and the surface of the component of ≦1 m, in particular of 0.5 m and less is used as air outflow source.

It is preferably provided that heated air in an appropriate quantity (≦2000 m³/(h lm)) is supplied in the lower component region via approximately horizontally running air outflow sources. That is, that overall an amount of air of ≦2000 m³ per hour and per linear metre of component length in relation to its horizontal longitudinal extension, is supplied via air outflow sources. The individual air outflow sources here run preferably linearly along the component at a horizontal distance from the component which is ≦1 m/s, measured from the component outer edge as a horizontal distance of the component outer edge, in particular in the case of a component having approximately rectangular cross-section or as a horizontal distance of a component outer region in the region of the greatest horizontal component extension, in particular in the case of a component having an approximately round, oval or elliptical cross-section, and the respective air outflow source, preferably measured as the component distance of surface—central axis of the pipe or hose section forming the air outflow source. The outflow of air at an air outflow source takes place with a low momentum, at an outflow velocity of, which is measured adjacent to the air outflow slit at the air outflow slit or at the air outflow openings.

Preferably an air source arranged at a horizontal and/or vertical distance from the component, running approximately parallel to the ground and/or running approximately horizontally is used as the air outflow source.

A specially configured arrangement as given in claim 8 is used for carrying out the method.

Here it is provided that one or more air outflow sources (16) are provided by means of which the warm air is supplied, in particular with a low momentum, at a predefined horizontal distance from the component in the base or fastening or standing region of the component and in order to achieve and sustain an, in particular surface-related homogenous surface temperature of the component, is guided by means of thermal flow effects substantially vertically along the component. It is hereby achieved that an optimal, in particular homogeneous surface temperature is achieved by optimal arrangement of the air outflow sources.

For the low-momentum outflow of the warm air, it is preferably provided that a pipe section with an outflow slit axially parallel to the pipe section, a pipe or hose section with a plurality of air outlet openings distributed over the circumference or a hose section with an air-permeable surface is provided as air outflow source.

The hose section can, for example, comprise an air-permeable synthetic fibre fabric, a cellulose fabric or another material suitable for a low-momentum passage of air. Instead of an outflow slit, a plurality of individual outflow openings (nozzles) which are arranged in a channel section can also be used.

It is fundamentally desired that the surface temperature distribution of the component to be dried is homogeneous so that the drying process takes place uniformly for the entire component. The positioning of the supply air apertures (hoses etc.) is preferably carried out depending on the component geometry.

It is preferably provided that in the drying position provided for the drying at least one pipe or hose section is arranged in the region of the ground surface preferably on each component longitudinal side.

According to a preferred embodiment, further pipe or hose sections are arranged approximately parallel to the ground spaced apart from one another in relation to the vertical component height on all component longitudinal sides.

In the event that a component to be dried has a circular or oval or similar cross-section, it is provided that at least one pipe or hose section is arranged on the bottom side or underside and one further pipe or hose section respectively is arranged preferably at least on each component longitudinal side.

By this means a surface overflow of the cylindrical component surface is produced, which in fact becomes detached in the upper section of the outer surface, i.e. therefore the section remote from the ground, where however at least one backflow eddy is produced, which results in a surface overflow of the entire freshly painted component surface.

### BRIEF DESCRIPTION OF THE DRAWINGS

Exemplary embodiments of the invention are explained in detail hereinafter with reference to the drawings. In the figures in purely schematic view:

FIGS. 1 and 2 show an arrangement according to the invention for drying a painted component in side view and in a view from the front, and

FIGS. 3 to 6 show further arrangements according to the invention for drying a painted component in a side view.

### PREFERRED EMBODIMENT OF THE INVENTION

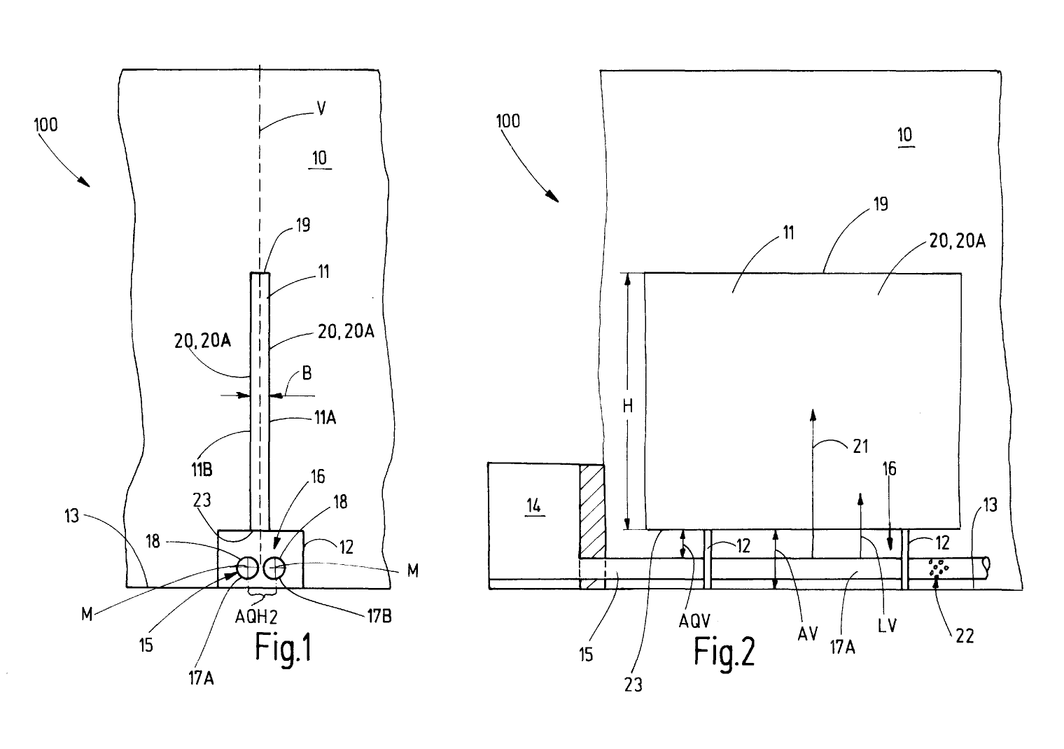

FIGS. 1 and 2 show an arrangement 100 for drying in a paint shop 10 merely indicated. Such a room can be the paint shop itself or another room for subsequent processing or drying of a component 11. The component 11 which has a larger height extension H than width B is held by means of a suitable holder 12 at a predefined vertical distance AV from the ground surface 13 in a vertical alignment V, where the holder 12 is configured so that it does not hinder an air flow around the component 11 except at the contact surfaces with the component 11.

Disposed outside the paint shop 10 is an air preparation system 14 with which air can be compressed and heated as well as moistened or dehumidified for providing drying air which is supplied to the paint shop 10. The drying air is supplied to the paint shop 10 via a channel system 15 which extends into the paint shop 10.

The arrangement according to the invention provides that the drying air introduced via the channel system 15 is supplied to the component 11 by using as a source for the drying air an air outflow source 16 arranged at a horizontal and/or vertical distance AQH, AQV (measured between the central line or central longitudinal axis M of the air flow source 16 and the surface 20 and/or the lower edge 23 of the component 11) from the component 11 where the air flow source 16 runs approximately parallel to the ground or approximately horizontally.

In the exemplary embodiment respectively one pipe section 17A, 17B is provided as air source, which has respectively one outflow slit 18 axially parallel to the pipe section 17A, 17B, from which the air flows onto the component 11 at the lowest possible outflow velocity LV and sweeps over the component 11 as far as its upper edge. The sweeping over is achieved whereby the air provided by the air preparation system 14 and supplied via the channel system 15 to the air outflow source 16 is heated so that a natural convection flow is obtained at the component, which has the result that flow takes place over the component for heating the surface 20. The pipe sections 17A, 17B have a horizontal central distance AQH2 from one another.

When a heating of the surface 20 has then been established, an used solvent and/or also moisture diffuses out from the component surface 20 of the component 11, which had previously been provided with a corresponding paint application 20A or from the surface layer of the paint application 20A respectively, and is removed by the air flow 21. The paint shop 10 has air removal devices, not shown in the drawing, which remove the solvent- and/or moisture-laden air from the paint shop 10.

The aim of the arrangement is to release an air flow 21 close to the component so that this optimally dries the component 11 and with regard to heating of the surface 20 and therefore the paint application 20A on the component 11 produces an optimal surface temperature which allows an out-diffusion of solvent and moisture and leads to a rapid drying of the paint application 20A. These conditions only need to be achieved near the component whilst the entire paint shop 10 can have a non-heated ambient or room temperature.

In order to achieve this, instead of the pipe section 17A, 17B with the outflow slit 18, it is possible to use a pipe section which, instead of one outflow slit, has a plurality of air outlet openings distributed along the circumference (indicated at 22) or the section can alternatively be configured as a hose section with an air-permeable surface. Here an air-permeable synthetic fibre or natural fibre fabric, a cellulose fabric or another material suitable for low-momentum passage of air is to be provided.

In the arrangement 100 according to FIG. 1, it is provided that the two adjacently arranged pipe sections 17A, 17B are arranged at a vertical distance AQV from the lower edge 23 of the component 11 and at a horizontal distance AQH2 in relation to their central lines from one another. The distance AQV can optionally also be negative, i.e. the air outflow sources are arranged above the lower edge of the component (20) when the special circumstances require this. In general, however, an arrangement below the component lower edge is to be strived for.

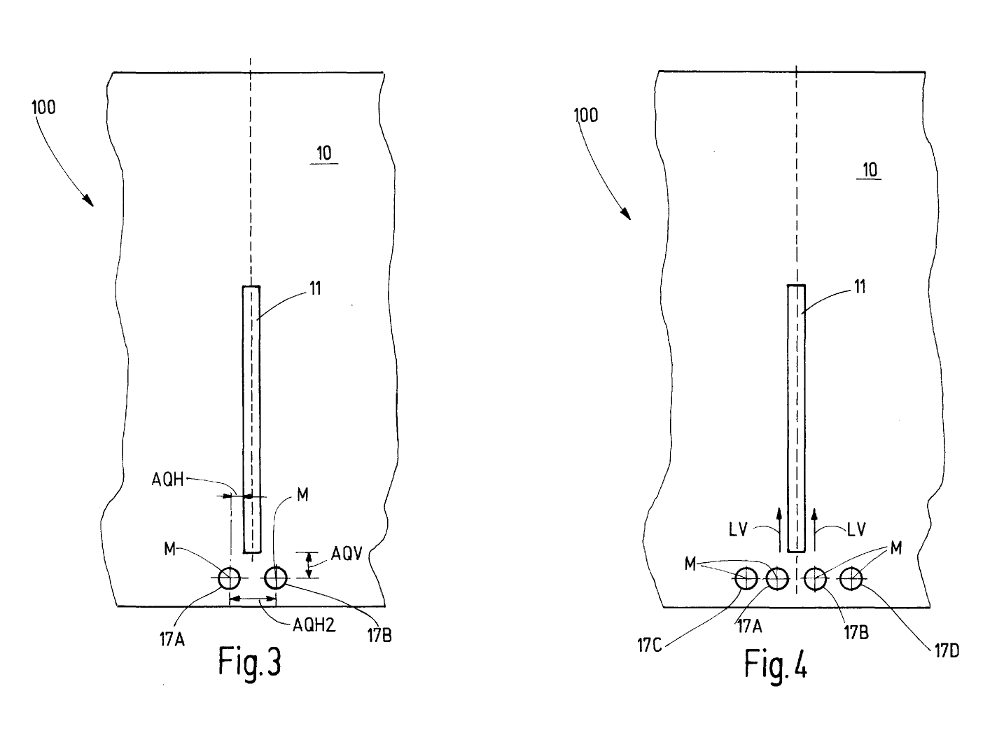

Alternative embodiments are shown in FIGS. 3 to 6.

According to FIG. 3, it is provided that compared with FIG. 1 the horizontal distance AQH of the two pipe sections 17A, 17B from one another is enlarged. In contrast the distance AQV to the lower edge 23 of the component 11 is reduced.

In the embodiment of the arrangement 100 according to FIG. 4, it is provided that additional pipe sections 17C, 17D are arranged parallel, which has the advantage that overall a quantitatively greater air flow is brought onto the component 11 at the same or lower air speed LV.

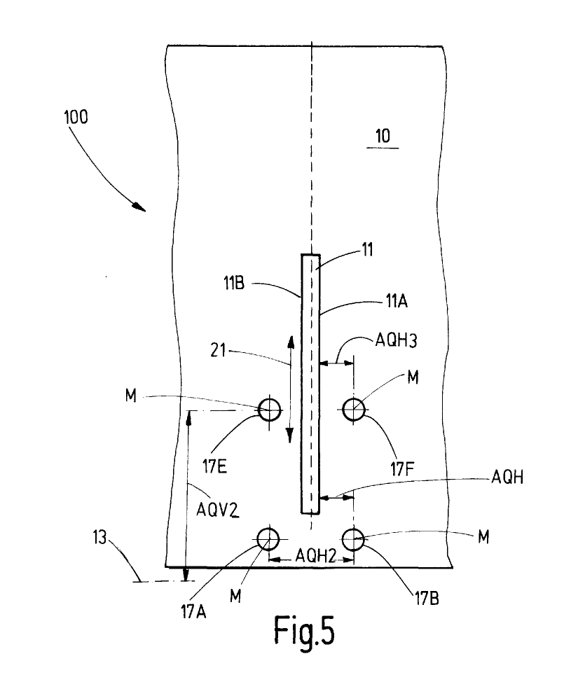

In the embodiment of the arrangement 100 according to FIG. 5, the horizontal distance AQH2 of the pipe sections 17A, 17B with respect to one another is again increased and in addition, pipe sections 17E, 17F are arranged in each case on one side of the component 11 ABH at a horizontal distance ABH3 to the component 11 and at a large distance AQV2 from the ground surface 13. Here it can advantageously be achieved that despite the accuring cooling of the air flow 21, an even more uniform temperature distribution at the surface 20 of the component 11 is achieved. The air flow 21 is the thermal air flow which, starting from the air outflow sources 17A and 17B, flows vertically over the component 11. The cooling results from the induction of (colder) ambient air in the thermal flow.

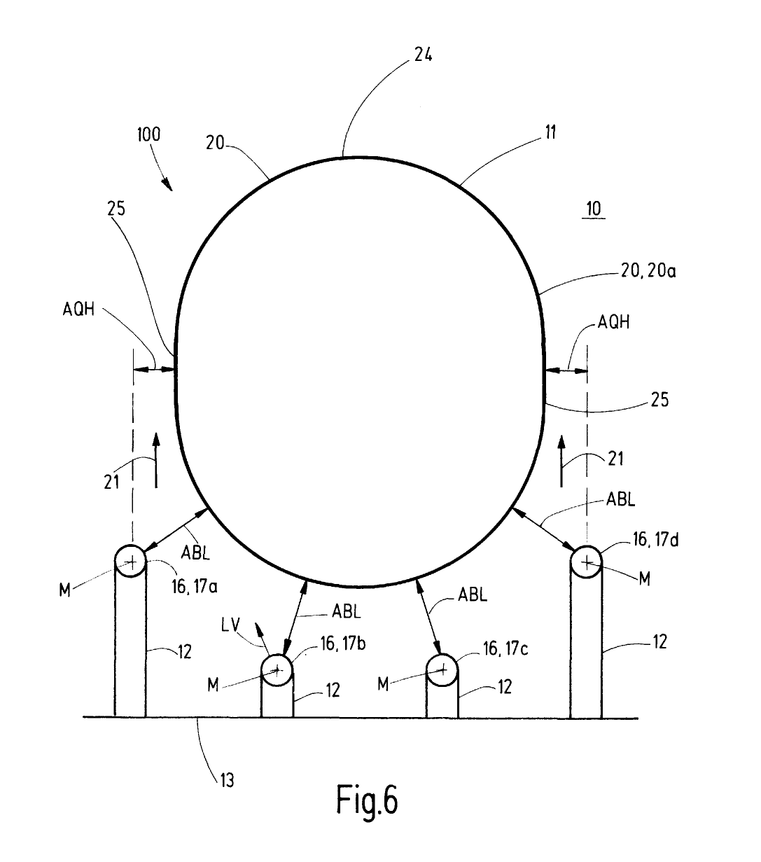

In the embodiment of the arrangement 100 according to FIG. 6 an aircraft fuselage in the paint shop 10 is indicated as an example component 11, of which only the outer outline line 25 is shown in the sectional view. Around the component 11 is in each case one pipe or hose section 17A, 17B, 17, 17D arranged as air outflow source 16 at a perpendicular distance ABL, measured between the central longitudinal axis of the pipe or hose section and the component surface 20, between the outer side of the air outflow source 16 and the component 11, where each section either has an outflow slit 18 axially parallel to the pipe section or preferably circumferentially arranged air outflow openings 22 from which air flows at the lowest possible outflow speed LV onto the component 11 and sweeps over the component 11 as far as into the region of its upper side. The sweeping over is achieved by the air provided by an air preparation system not shown and supplied via a channel system to the respective air outflow source 16 being heated so that a natural convection flow is obtained at the component 11 which has the result that flow takes around the component 11 preferably homogeneously or almost homogeneously, i.e. with small differences with regard to the surface temperature for heating the surface 20.

As already explained, the heating of the surface 20 has the result that solvent and/or moisture is removed from the surface layer of the paint application 20A and is guided by means of the air flow 21 away from the component 11 to a vent not shown.

The arrangement of the air outflow source 16 is such that the air outflow sources 16 (pipe sections 17A, 17D) each arranged outside right and left in the plane of the drawing are arranged at a predefined horizontal distance AQH between the air outflow source 16 and the component surface in relation to the round or oval cross-section in the central component surface region 25. This ensures that primarily the air required to form a convention flow at the component surface 20 is provided without the need for complete heating of the paint shop. This is not only energetically advantageous but also appropriate so that the necessary convection flow is established which is based on the fact that the air flow 11 supplied accordingly to the component 11 is air which is heated compared with the room air temperature in the paint shop 10 so that an overflow of the surface 20 and therefore of the paint application 20A of the component 11 takes place as a result of the thermals. Further drying air is provided via the further pipe sections 17B, 17C which are also arranged at a distance ABL from the component surface 20.

### REFERENCE LIST

Arrangement 100
Paint shop 10
Component 11
Holder 12
Ground surface 13
Air preparation system 14
Channel system 15
Air outflow source 16
Pipe or hose sections 17A, 17B, 17C, 17D, 17E, 17F
Outflow slit 18
Upper edge 19
Surface 20
Paint application 20A
Air flow 21
Opening 22
Lower edge 23
Upper side 24
Outline 25
Height H
Width B
Vertical distance AV
Vertical distance air flow source AQV
Horizontal distance air flow source AQH, AQH2
Air speed LV
Horizontal distance air outflow source-component ABH
Vertical distance air outflow source-component ABL
Central longitudinal axis M

What is claimed is:

1. Method for drying a component provided with a paint application by means of supplied warm air, wherein the warm air is supplied in particular with a low momentum, at a predefined horizontal distance from the component in the base or fastening or standing region of the component, and in order to achieve and sustain an, in particular surface-related homogenous surface temperature of the component, which in particular is higher than the ambient or room air temperature in the paint shop, is guided by means of thermal flow effects substantially vertically along the component and/or over and along the surface of the component.

2. The method according to claim 1, wherein appropriate air flows are brought to the painted component to be dried and are released having a low momentum in the direct surroundings of the component at a predefined distance, where the air flows consist of heated air compared with the ambient or room temperature air in the paint shop so that a flow over the surface of the component results by means of the thermals.

3. The method according to claim 1, wherein heated air sweeps over the component in appropriate quantity.

4. The method according to any one of the preceding claims wherein at least one air source arranged at a horizontal and/or vertical distance from the component, running approximately parallel to the ground and/or running approximately horizontally is used as air outflow source.

5. The method according to claim 4, wherein a pipe section and/or a hose section, which is arranged at a distance, measured between the central longitudinal axis of the pipe or hose section and the surface of the component of ≦1 m, in particular of 0.5 [m] and less is used as air outflow source.

6. The method according to any one of claims 1 to 5, wherein heated air in a quantity of ≦2000 m³/(h lm) is supplied for drying the component via one or more air outflow sources per hour and per linear metre of component length, measured in the horizontal extension, at least in the lower component region.

7. The method according to any one of claims 1 to 6, wherein the supplied warm air flows out from each air outflow source with a low momentum, i.e. at an outflow velocity of ≦1 m/s, in particular of 0.5 m/s or less.

8. Arrangement for drying a component provided with a paint application by means of supplied warm air, in particular according to the method according to claim 1 to 7, wherein one or more air outflow sources are provided by means of which the warm air is supplied in particular with a low momentum, at a predefined horizontal distance from the component in the base or fastening or standing region of the component, and in order to achieve and sustain an, in particular surface-related homogenous surface temperature of the component, which in particular is higher than the ambient or room air temperature in the paint shop, is guided by means of thermal flow effects substantially vertically along the component and/or over and along the surface of the component.

9. The arrangement according to claim 8, wherein a pipe section with an outflow slit axially parallel to the pipe section, a pipe or hose section with a plurality of air outlet openings distributed over the circumference or a hose section with an air-permeable surface is provided as air outflow source.

10. The arrangement according to claim 8 or 9, wherein the hose section comprises an air-permeable synthetic fibre fabric or cellulose fabric or another material suitable for a low-momentum passage of air.

11. The arrangement according to any one of the preceding claims 8 to 10, wherein in the drying position provided for the drying at least one pipe or hose section is arranged in the region of the ground surface of the component on each component side.

12. The arrangement according to any one of the preceding claims 8 to 11, wherein further pipe or hose sections are arranged approximately parallel to the ground spaced apart from one another in relation to the vertical component height on all component longitudinal sides.

13. The arrangement according to any one of the preceding claims 8 to 12, wherein for drying an aircraft fuselage section and/or an aircraft fuselage as component, at least one pipe or hose section is arranged on the bottom side or underside and respectively one further pipe or hose section is arranged at least on each fuselage longitudinal side of the fuselage.
